(19) United States
(12) Patent Application Publication
(10) Pub. No.: US 2014/0072679 A1
(43) Pub. Date: Mar. 13, 2014

(54) AUTOMATED BEVERAGE PRODUCTION AND MONITORING SYSTEM

(71) Applicant: Be Labs, LLC, Seattle, WA (US)

(72) Inventor: Edward Balassanian, Seattle, WA (US)

(73) Assignee: Be Labs, LLC, Seattle, WA (US)

(21) Appl. No.: 14/033,065

(22) Filed: Sep. 20, 2013

Related U.S. Application Data
(63) Continuation of application No. 14/020,836, filed on Sep. 7, 2013.
(60) Provisional application No. 61/698,354, filed on Sep. 7, 2012.

(51) Int. Cl. A23L 2/02

(52) U.S. Cl. CPC A23L 2/02
USPC 426/231; 99/275

(57) ABSTRACT

Methods and systems describing preparation of a beverage are described. One embodiment includes preparing a beverage taking into account properties of an ingredient, such as sugar content of apple juice, as well as an individual's health data such as the individual's insulin level. Other embodiments include preparing a beverage based on data such as an individual's goal to lose weight. Some embodiments include a recipe such as a beverage recipe to start preparing the beverage. In some embodiments, the ingredients, amount, and instructions in a recipe may remain the same or be changed depending on factors such as health data, properties of an ingredient, and others. In other embodiments, a beverage is prepared so that the beverage meets a set of predetermined threshold criteria such as a pH level, and the ingredients and the amounts of the ingredients may be adjusted to meet these criteria.

### CROSS-REFERENCE TO RELATED APPLICATION

This application is a continuation of U.S. application Ser. No. 14/020,836, filed Sep. 7, 2013, which claims the benefit of, and priority of U.S. Provisional Appl. No. 61/698,354, filed Sep. 7, 2012; the disclosures of each of the above-referenced applications are incorporated by reference herein in their entireties.

### BACKGROUND

1. Technical Field

The present disclosure generally relates to methods and systems of preparing beverages, and more particularly relates to methods and systems of analyzing ingredients and preparing beverages that meet certain criteria.

2. Background

Currently, most beverages are mass-produced for the general population. Many of the pre-packaged beverages are made using either artificial ingredients such as sugar and additives, or concentrates or a combination of the two. As a result, the public's choice of beverages has been limited to what was manufactured and not necessarily what is most desired or beneficial from an individual's stand point. Such mass-produced artificially enhanced beverages are not generally the beverage of choice for many individuals, particularly those who are health conscience, and/or those with a restricted diet or other specific requirements and/or goals.

Beverage manufacturers, on the other hand, typically do not produce products to meet individual requests. The divide between what is being produced by the manufacturers and what is desired by an individual may be bridged by producing customized beverages for the individuals.

A beverage distributor or seller, generally interacting with both the beverage manufacturers and the individuals, wish to generate more sales. For example, a seller who also owns a gym may benefit from introducing a beverage particularly designed for his gym clients. The beverage sellers, like the individuals, do not have the means to manufacture such beverages targeted for certain individuals. The beverage sellers may also profit from customized beverages.

As overall health consciousness throughout the world has increased, the population has an increasing desire to improve health and monitor food intake. For example, general health-consciousness and orientation to low-sugar and/or high-fiber diet are making consumers avoid artificial sugar which can cause obesity and decayed teeth, especially in the area of beverages. A general trend in beverages may be going toward using ingredients that are minimally processed, natural, and/or seasonal. Such beverages may contain be more beneficial as they may contain higher levels of fiber, vitamins, antioxidants and other components. Artificial beverages, generally required to have an extended shelf-life, have the additional shortcoming of not satisfying the consumer desire for more healthful and more natural beverages.

Because artificial beverages cannot sufficiently meet various needs and requirements of the population, there is a need for methods and systems of preparing beverages for a health conscience population.

### BRIEF DESCRIPTION OF THE DRAWINGS

FIG. 1. illustrates an embodiment of a beverage preparation based on user input and ingredients data.

FIG. 2. illustrates an embodiment of a system to prepare a beverage based on user data and ingredients data.

FIG. 3. illustrates an embodiment of a system to prepare and provide a customized beverage.

FIG. 4 illustrates another embodiment of a system to prepare and provide a customized beverage.

FIG. 5 illustrates an embodiment of a system process flow for a beverage preparation.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

This specification may use phrase such as “based on.” As used herein, this term is used to describe one or more factors that affect a determination. This term does not foreclose additional factors that may affect a determination. That is, a determination may be solely based on those factors or based only in part on those factors. Consider the phrase “determine A based on B.” This phrase connotes that B is a factor that affects the determination of A, but does not foreclose the determination of A from also being based on C. In other instances, A may be determined based solely on B.

### DETAILED DESCRIPTION

A user may benefit from a beverage prepared with a target to meet certain specific requirements of the user. While a user's specific requirements may vary from one user to the next, each individual ingredient used to prepare the beverage may also vary from one to another. When the variations in individual ingredients are taken into account, the resulting beverage may closely comply with the specific requirements of the user.

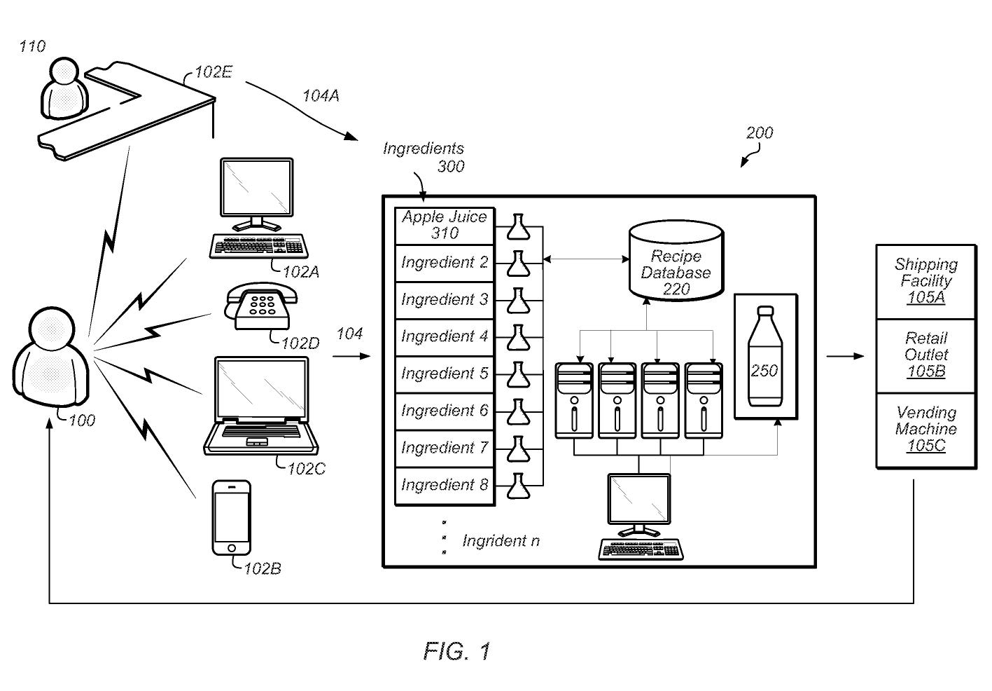

FIG. 1 illustrates one embodiment of a beverage prepared based on user request. As used herein, the term “user” includes an individual, a person, an end-user such as consumer and/or customer. The term “user” does not exclude buyers or distributors. A “user” includes those who are not directly or physically operating devices or apparatus. In an exemplary embodiment, user 100 enters a beverage order via network 104 by way of computing device 102A (which may be included in other devices such as a vending machine not separately shown), smart phone 102B, laptop 102C, telephone 102D, and/or by way of other types and kinds of devices and methods. User 100 may also place, either remotely or in person, a beverage order via retail outlet 102E. Attendant 110 may be present at retail outlet 102E. Retail outlet 102E in turn may cause the beverage order to be processed via communication link 104A. Communication link 104A may or may not be the same as network 104.

In some embodiments, user 100 provides data such as personal data including gender, age, fitness and/or exercise level, types of allergy, weight, body mass index, insulin level, symptoms such as insomnia, and laboratory test data such as red blood cell count and others. In one embodiment, system 200 selects, from database 202, a recipe for the beverage. For example, a recipe with low or zero caffeine may be selected based on the insomnia of user 100. As another example, a recipe with low sugar content may be selected based on the insulin level of a diabetic user 100. As used herein, the word “content” and the word “level” is each used to describe a characteristic including, but not limited to, a numerical value, a concentration, a level, a range, a limit, a standard, a threshold, a percentage, a comparative value, a quantified or an unquantified amount, value, volume or others.

In the embodiment of diabetic user 100, a low-sugar beverage recipe may include apple juice 310 along with other ingredients generally illustrated as ingredients 300. Apple juice 310 may be freshly squeezed from organic apples. As a further embodiment, apple juice 310 may be freshly squeezed from organic apples including “Red Delicious” apples and other varieties. Depending on the apples (i.e., different varieties, different seasons of the year, different farmers, etc.) used to produce apple juice 310, however, the sugar content of apple juice 310 may vary. System 300 analyzes ingredients 300 such as apple juice 310 to determine various properties of apple juice 310.

The various properties of ingredients 300 (including apple juice 310) may include chemical properties such as pH level, pathogen content, bacteria content, acidity level, alkalinity level, water content, mold content, yeast content, allergen content, saturated fat content, unsaturated fat content, trans-fatty acid content, amino-acid content, sodium content, preservative content, mineral content, electrolytes content, fiber content, antioxidant count, and others.

Properties of ingredients 300 may also include physical properties such as temperature, pressure, viscosity, density, color, solubility, fluidity, refractive index, and others. System 200 may analyze one, some or all ingredients 300 (1-n). Ingredients may include vegetables, fruits, juices, purees, soups, oils, nuts, legumes, grains, spices, dairy items, vitamins, herbs, starches, and other items.

These properties define certain aspects or characteristics of an ingredient. The measurement, analysis, or determination of these properties include, but are not limited to, a numerical value, a range, a concentration, a limit, a standard, a threshold, a percentage, a comparative value, a quantified, or an unquantified amount, volume, value or others. For example, a pathogen count of an ingredient may be analyzed based on a threshold criterion such as a maximum acceptable pathogen count. The criterion may be predetermined, adjusted based on a predetermined criterion, or otherwise. As another example, a user with peanut allergy likely requires a beverage with a low or zero peanut (allergen) count, while users without peanut allergy may not have such requirement. And therefore, for users without peanut allergy, a threshold of peanut count may be increased for a particular beverage.

In certain embodiments, system 200 may extract a sample of one of ingredients 300 for testing or analyzing. The amount of the sample and the type of testing may vary. For example, without limitation, relevant tests and/or analyses may determine various properties include one or more of the following:
Acidity level: acidity may impact shelf-life, coloration, oxidation, and/or taste of a beverage. The level of acidity in a beverage may be adjusted by either changing an ingredient or changing an amount of an ingredient or both. For example, citrus fruits generally have higher acidity levels than other ingredients; among citrus fruits with various acidity levels, lemons generally have a higher acidity level, and oranges or pomelos may have a lower acidity level. Determining acidity levels of various ingredients may help to select ingredients and their amounts to meet certain criteria, parameters, specifications, or goals of a beverage.
Alkalinity level: alkalinity may neutralize an acid and therefore may have an impact on the acidity level.
Sugar content: sugar content has an impact on various parameters of a beverage, including taste, calories, carbohydrate content, energy, shelf-life, and other aspects. For example, for a particular beverage for a marathon runner whose energy and stamina needs to be sustained, a beverage using only ingredients with low sugar content may not be the beverage of choice. On the other hand, if a diabetic person prefers, for example, a low-sugar beverage which contains apple juice, certain apples with lower sugar content (less sweet apples) may be used in place of those apples with an average or higher sugar content.
Pathogen count: pathogens may impact the shelf-life, taste, and hygiene of the beverage. In one embodiment, all or parts of system 200 may be temporarily suspended if a higher than acceptable threshold pathogen count is found in an ingredient.
Water content: water provides hydration but may also dilute a beverage. Water content may also impact the taste and texture of the beverage. For example, a beverage using spinach juice with higher water content may require less spinach juice to satisfy the water content requirement of the beverage. As another example, a beverage may have both minimum and maximum criteria for water content.
Color: the color of a beverage may indicate an overall freshness and healthful disposition. For example, a dark green beverage may be perceived as fresher and/or more healthful than a dark brown beverage. Color may be determined and/or monitored by analyses including a spectrum analysis.
The above list is provided for illustrated purposes only and is not a limitation to the disclosure. As a non-limiting example, using the relevant tests and the resulting properties above, ingredients and amounts of the ingredients may be specified to prepare a low-sugar, citrus, dark green beverage with a certain shelf-life such as 24 to 36 hours for a user who wishes to reduce or manage the user's insulin level.

When system 200 determines a set of ingredients and amounts of ingredients for the beverage, the completed beverage 250 can be prepared using these ingredients and made available to user 100. Additional details regarding preparing the beverage will be discussed in later sections. User 100 may receive beverage 250 from a retail location 105B (which may or may not be the same as retail counter 102E), a vending machine 105C, or via shipment 105A, or other methods or means.

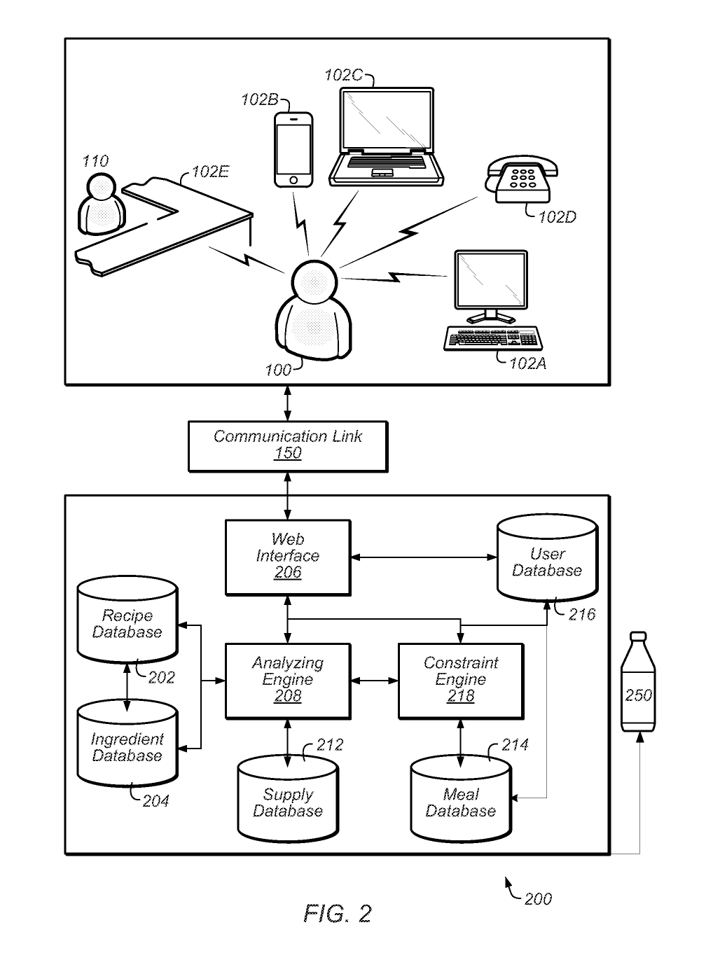

Turning to FIG. 2 which is an embodiment of a system of preparing a beverage. User 100 may enter a beverage order via communication link 150 by a variety of means and devices. In this embodiment, communication link 150 is communicatively linked to web interface 206. User 100 may provide health goal such as certain metabolic goals including a weight goal, a body mass index goal, a goal to limit caloric consumption which may include a vitamin intake goal, an insulin intake goal, a fiber intake goal, a protein intake goal, a water intake goal, an exercise goal, and others. Other health goals may include unquantified goals such as ‘sleep better,” “more energy,” and others.

Upon receiving data from user 100, system 200 may select a stored beverage recipe from recipe database 202. FIG. 2 also illustrates ingredient database 204 which may include a variety of ingredients associated with the recipe database 202, whether the ingredients are immediately available or not. These and other databases of system 200 may be modified and/or edited.

For user 100 who may have a goal to lose weight, system 200 may select a stored recipe with low calorie content. User 100 may additionally have a vigorous exercise goal and may benefit from a high protein beverage. In this particular embodiment, system 200 may initially select a stored recipe which includes milk as an ingredient, for milk generally has high protein content. System 200 may, however, adjust the recipe, taking into account the goal to lose weight and other factors. Analyzing engine 208 may analyze and determine various properties of ingredients. For example, analyzing engine 208 may analyze a fat content of whole milk. In one embodiment, analyzing engine 208 may compare fat content of the whole milk to a threshold, a standard, or other similar types of boundary conditions.

Depending on the fat content and other properties of whole milk, system 200 may select skim milk instead of whole milk to reduce the overall calorie of the beverage. In other cases, system 200 may reduce the amount of whole milk used for the beverage, and/or add another ingredient (such as soy milk) that was not in the originally selected recipe. Supply database 212 may provide data relevant to the availability of ingredients and/or vendors from whom ingredients may be obtained.

In one embodiment, system 200 may use a reduced amount of whole milk and add to the originally selected recipe a certain amount of soy milk to meet the caloric and protein requirements of the beverage. If supply database 212 determines that an ingredient such as soy milk is not immediately available, system 200 which includes supply database 212 may determine if the ingredient may become available through other vendors or other channels.

In yet another embodiment, system 200 may have available soybeans instead of soy milk, and system 200 may make the soy milk from the soy beans. In this case, the originally selected recipe would additionally include a set instructions and relevant amounts of ingredients for the soy milk as an added ingredient for the beverage. System 200 which may include constraint engine 218 may additionally adjust the originally selected recipe, for example, by adjusting the length of time the ingredients are emulsified to account for the use of a new ingredient, in this case, soy milk instead of milk.

Moreover, user 100 may provide data such as preferences of a beverage. For example, user 100 may prefer a certain flavor, a texture, a shelf-life, an aesthetic component, and/or other characters of a beverage. For example, user 100 may prefer a beverage flavor that is sweet, bitter, sour, salty, savory, pungent, metallic, spicy, hot, warm, cold, icy, citrus, mild, chocolaty, vanilla, fruity, floral, umami, tangy, earthy, smoky, berry, or others. Flavor may include various levels, for example, a diagram of a pepper of a beverage may indicate that the beverage is spicy; whereas a diagram of three peppers may indicate that the beverage is spicier than the one with the one pepper diagram. As used herein, the word “flavor” includes taste and/or smell, objective and/or subjective perceptions, and/or sensations, whether quantifiable or not. Moreover, the word “flavor” is not limited to trigeminal senses but may include other senses.

Similarly, a beverage texture may be creamy, crisp, chunky, or other objective or subjective perceptions or characters. A shelf-life may be specified, for example, by an expiration date of the beverage. An aesthetic component may include a general appearance of the beverage. An aesthetic component may include both objective and subjective preferences, perception, feelings, and/or sensations. An aesthetic component is not limited to visual and may include other sensory components. Other embodiments may include a default set of flavor, texture, an aesthetic component, and/or shelf-life for a beverage. Similar to “one/three pepper diagram” discussed in relation to flavor above, any or all of user preferences may include, or be characterized by, various levels, ratings, scales, or others.

Moreover, if user 100 subsequently chooses to order the same beverage, instead of providing various data again, user 100 may instead provide data of the previously prepared beverage. Based on the data of the previous beverage, system 200 may prepare another similar beverage for user 100. In some embodiments, the data includes a bar code, a Quick Response Code (“QR Code”), other machine-readable codes, or other types of representation. Yet in other embodiments, the modified recipe (with the added soy milk, for example) may be stored along with a profile for user 100 by system 200 which may include user database 216.

System 200 may create, store and maintain a profile (not separately shown) for user 100. The profile may include personal data of user 100 such as age and gender. The profile may include various goals of user 100 such as weight loss goals. The profile may be used to track and/or trend various goals such as a progress of weight loss over a period of time. The profile may include historical data such as weight, body mass index, and other data over time. In some embodiments, user 100 may create, enter, access, delete, and/or edit the profile. In some embodiments, the profile may include particular recipes, either from a previously prepared beverage or otherwise. In yet other embodiments, meal database 214 in system 200 may store meal recipes including beverage recipes of user 100.

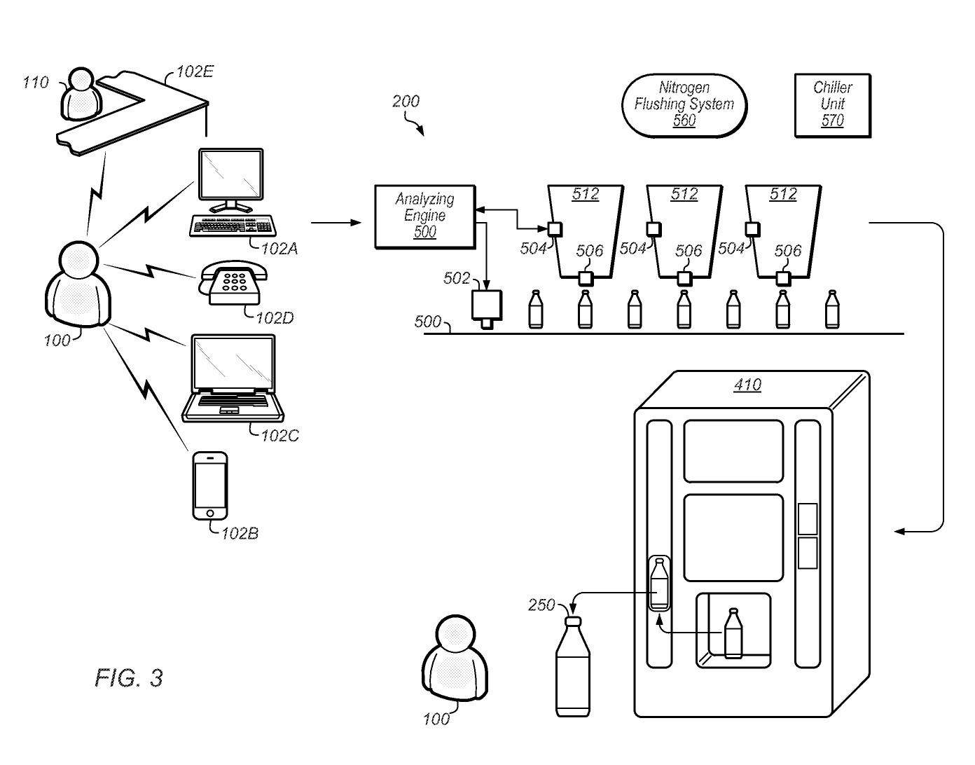

Turning now to FIG. 3, an embodiment is illustrated showing user 100 placing a beverage order by various methods. In this embodiment, various bins 512 store ingredients 300 (not shown for simplicity). Individual ingredient may be stored in individual bins or multiple ingredients may be stored in the same bin. Tester 504 extracts a portion of an ingredient from bin 512 for testing and/or analyzing. As discussed earlier, various tests and analyses may be performed to determine properties of an ingredient. Based on the test/analysis results, system 200 which may include analyzing engine 500 may determine the list of particular ingredients, amounts of the ingredients, and preparation instructions for beverage 250. Particular data including the specific ingredients and ingredients amounts for beverage 250 may be contained in bar code 502. Bar code 502 may be scanned, in some embodiments, by a device which may in turn instruct assembly line 500 to begin preparing the beverage.

In FIG. 3, spigot 506 measures and releases the specified amount of a selected ingredient. Other ingredients may be similar dispensed. Assembly line 500 may be machine operated, manually operated, or a combination of the two. Following the preparation instructions included in a recipe, beverage is prepared accordingly.

Assembly line 500 may include nitrogen flushing system 560 which may be used to remove oxygen from bins 512. Moreover, when bin 512 is empty, it may be flushed with nitrogen to minimize the risk of oxidation or contamination. Chiller 570 may be included to maintain a threshold temperature of ingredients 300 (not separately shown) in order to reduce bacteria growth and control temperature. As discussed earlier, finished products may be received by user 100 in a variety of ways. FIG. 3 shows that in some cases, user 100 may obtain beverage 250 from vending machine 410.

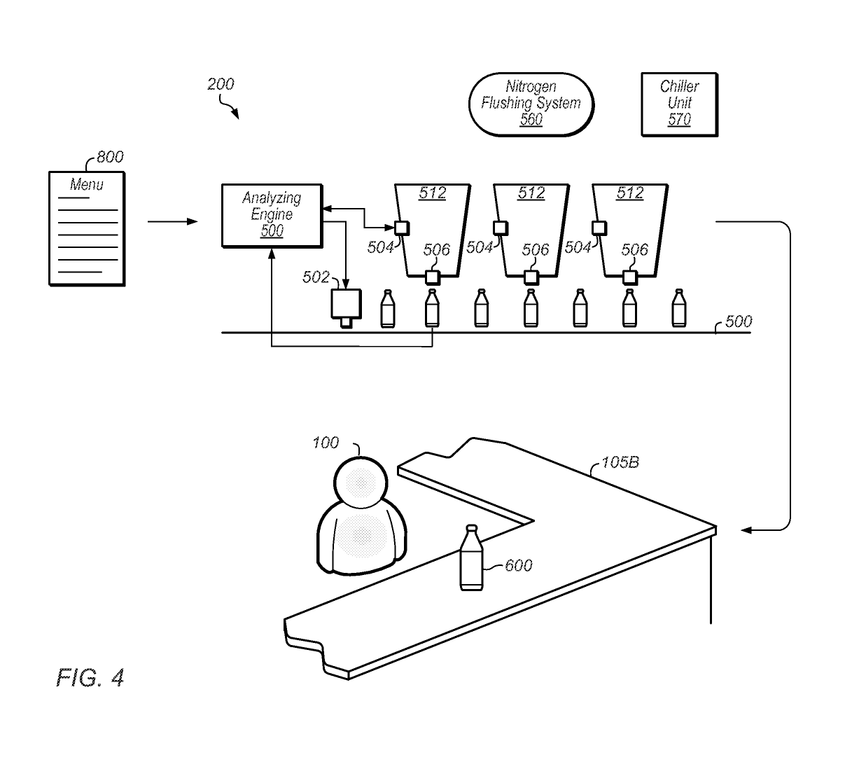

FIG. 4 shows that beverage 250 may be available in retail location 105B which may or may not be the same as location 102E. Retail location 105B may include menu 800 offering, for example, beverage 600 with a set of predetermined properties, specifications and/or parameters. In FIG. 4, system 200 may analyze prepared beverage 600 to ensure that properties, specifications, and parameters of beverage 600 meet certain predetermined criteria. For example, a beverage 600 has a requirement that it should have less than 10 grams of sugar. Analysis shows, however, that this particular beverage 600 contains a sugar content of 15 grams rendering it outside of the threshold for sugar content. Adjusting ingredients, amounts of the ingredient, or both may bring beverage 600 within the threshold sugar content. System 200 may therefore adjust these factors so that the resulting beverage 600 may satisfy the criterion. Upon meeting the specified criteria, beverage 600 is then provided for consumption or purchase.

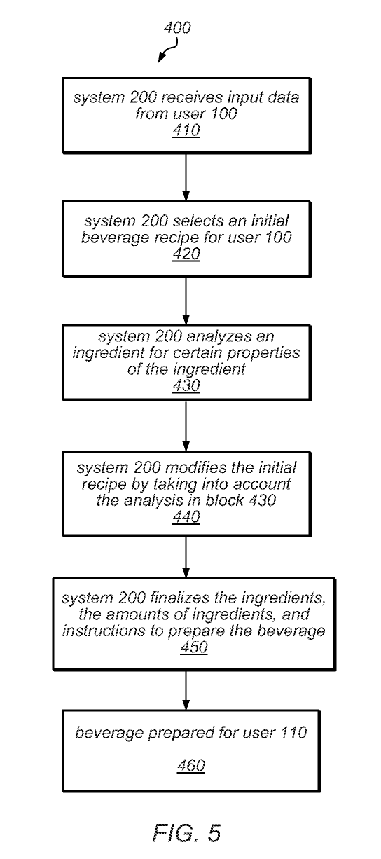

FIG. 5 is a flow diagram illustrating one exemplary embodiment of a method 400 for preparing a beverage. The method shown in FIG. 5 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired. Flow begins at block 410.

At block 410, system 200 receives input data from user 100. The input data may include data such as a body mass index, health goals such as a goal to lose weight, beverage preferences such as a flavor of the beverage, and data related to previously prepared beverages. Flow proceeds to block 420.

At block 420, system 200 selects an initial beverage recipe for user 100. The selecting may take into account input data discussed in block 410. A beverage recipe may include a list of ingredient, amount of each ingredient, and instructions including time parameter to prepare the beverage. Flow proceeds to block 430.

At block 430, system 200 analyzes an ingredient for certain properties of the ingredient. As discussed earlier, the analysis may show that the ingredient (e.g., apple juice) has a certain sugar content or other properties. Flow proceeds to block 440.

At block 440, system 200 modifies the initial recipe by taking into account the analysis in block 430. Depending on the analysis, system 200 may add, subtract, and/or replace one or more ingredients in the initial recipe. System 200 may increase or reduce an amount of an ingredient in the initial recipe. System 200 may change the instructions in the initial recipe. For example, the initial receipt may instruct that an ingredient in the recipe should be steamed for a certain length of time. In modifying the initial recipe, system 200 may lengthen or shortened the length of steaming time, or replace it with a different instruction. Flow proceeds to block 450.

At block 450, system 200 finalizes the ingredients, the amounts of ingredients, and instructions to prepare the beverage. In some embodiments, this set of data may constitute a final recipe of the beverage. At least a portion of the final recipe may be represented by a machine-readable code such as a QR code. Relevant equipment in system 200 may scan the machine-readable code and atomically prepare the beverage. In other embodiments, the final recipe may be a set of detailed instructions for a human operator to prepare the beverage. Flow proceeds to block 460.

At block 460, beverage is prepared for user 100, and process 400 ends at block 460.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, at a computer-based system, a set of input data from a user;
selecting, by the computer-based system, a plurality of ingredients for a beverage for the user, wherein the selecting is based on the set of input data, and wherein the selecting includes analyzing one or more ingredients by the computer-based system and determining the plurality of ingredients based on the analyzing;
causing the beverage for the user to be prepared by the computer-based system using the selected plurality of ingredients.

2. The method of claim 1, wherein the analyzing includes testing to determine one or more properties of an ingredient.

3. The method of claim 2, wherein the one or more properties include one or more of the following properties: a physical property, a chemical property.

4. The method of claim 1, wherein the selecting further includes:
determining a preliminary plurality of ingredients based on the set of input data; and,
analyzing one or more of the preliminary plurality of ingredients.

5. The method of claim 4, wherein the analyzing includes comparing at least one property of at least one of the preliminary plurality of ingredients to a threshold criterion.

6. The method of claim 4, further comprising:
in response to the analyzing, adjusting the preliminary plurality of ingredients.

7. The method of claim 6, wherein the adjusting includes adding one or more other ingredients to the preliminary plurality of ingredients to select the plurality of ingredients.

8. The method of claim 1, further comprising:
based on the analyzing, the computer-based system determining an amount of at least one of the plurality of ingredients.

9. The method of claim 1, wherein the selecting further includes selecting a recipe based on the set of input data, and wherein the recipe specifies a preliminary plurality of ingredients and instruction for combining the preliminary plurality of ingredients.

10. A system comprising:
a processor,
a memory having instructions stored thereon that, in response to execution by the processor, cause the processor to perform operations comprising:
receiving input data that includes personal data of a user and a health goal of the user;
selecting one of a plurality of beverage recipes, wherein the selected beverage recipe specifies amounts of a plurality of ingredients and instructions for preparing the beverage, and wherein the selecting is based on the personal data and the health goal of the user;
preparing a beverage for the user.

11. The system of claim 10, wherein the health goal of the user includes a metabolic goal.

12. The system of claim 10, wherein the personal data includes data indicative of a beverage previously prepared for the user.

13. The system of claim 12, wherein the data indicative of the previously prepared beverage includes a bar code.

14. The system of claim 10, wherein the selected recipe further specifies a length of time for preparing a least a portion of the beverage.

15. The system of claim 10, wherein the operations further comprise:
based on an analysis of one or more ingredients, preparing the beverage for the user using at least a portion of the selected recipe.

16. The system of 10, wherein the operations further comprise:
based on an analysis of one or more of the plurality of ingredients, adjusting an amount of at least one of the plurality of ingredients specified in the selected recipe; and
preparing the beverage for the user using the adjusted amount of the at least one ingredient.

17. A system comprising:
a processor; and
a memory having instructions stored thereon that, in response to execution by the processor, cause the processor to perform operations comprising:
receiving a set of threshold criteria for a beverage;
selecting one of a plurality of beverage recipes, wherein the selected beverage recipe specifies amounts of a plurality of ingredients and instructions for preparing the beverage using the specified plurality of ingredients, and wherein the selecting is based on the set of threshold criteria; and
modifying the selected recipe based on an analysis of at least one of the specified plurality of ingredients; and
preparing the beverage using the modified recipe.

18. The system of claim 17, wherein the analysis includes comparing a property of one of the plurality of ingredients to one or more of the set of threshold criteria.

19. The system of claim 18, wherein the property is a composition.

20. The system of claim 17, wherein the set of threshold criteria of the requested beverage includes a minimum and a maximum sugar content.

21. The system of claim 17, wherein the modifying includes changing the instructions specified in the selected recipe.

22. The system of claim 21, wherein the changing includes adding another ingredient to the selected recipe.

23. A method, comprising:
selecting, by a computer-based system, an amount of an ingredient for a beverage for a user, wherein the selecting is based on a plurality of health data of the user, and wherein the selecting includes analyzing the ingredient by the computer-based system and determining the amount of the ingredient based on the analyzing; and
causing the beverage to be prepared by the computer-based system using the selected amount of the ingredient.

24. The method of claim 23, further comprising maintaining, by the computer-based system, a user profile that includes health data of the user.

25. The method of claim 23, wherein the health data of the user includes a plurality of health data of the user over a length of time.

26. The method of claim 23, wherein the selecting further includes:
determining a preliminary amount of the ingredient based on the health data of the user; and,
analyzing the ingredient.

27. The method of claim 24, wherein the user profile includes beverage preferences of the user, and wherein the selecting is further based on the beverage preferences of the user.

28. The method of claim 27, wherein the beverage preferences of the user includes one or more of the following preferences: a texture, a shelf-life, and a flavor.
